(19) United States
(12) Patent Application Publication
(10) Pub. No.: US 2009/0206725 A1
(43) Pub. Date: Aug. 20, 2009

(54) Discharge tube array

(75) Inventors: Hitoshi Hirakawa, Hyogo (JP); Manabu Ishimoto, Hyogo (JP); Kenji Awamoto, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: Shinoda Plasma Corporation, Kobe-shi, Hyogo (JP)

(21) Appl. No.: 11/921,707

(22) PCT Filed: Jun. 9, 2005
(86) PCT No.: PCT/JP2005/010565

§ 371 Date: Dec. 6, 2007

(51) Int. Cl. H01J 1/62

(52) U.S. Cl. 313/491

(57) ABSTRACT

A discharge tube array includes a plurality of elongated discharge tubes (10) each including an internal fluorescent layer. The discharge tubes (10), arranged in parallel, are sandwiched between paired substrates (20, 21). One of the substrate (20) is provided with a plurality of display electrodes (30) each extending across the discharge tubes (10). A plurality of connection terminals (14) are formed on the tube wall of the outermost one of the discharge tubes (10), to be connected with the display electrodes (30). The connection terminals (14) are primarily for electrical connection with the display electrodes of another discharge tube array.

### TECHNICAL FIELD

The present invention relates to a discharge tube array utilized for providing e.g. a flat display panel.

### BACKGROUND ART

A conventional discharge tube array is disclosed in Patent Document 1 listed below. The discharge tube array has a laminate structure including a transparent front substrate and a back substrate between which a plurality of discharge tubes are disposed in parallel and bonded to the two substrates. Each discharge tube has a diameter not greater than 2 mm and a length not smaller than 300 mm, for example. Inside the tube is provided with a fluorescent layer. The front substrate has an inner surface provided with display electrodes across and in contact with the arrayed discharge tubes. The back substrate has an inner surface provided with address electrodes each along and in contact with one of the discharge tubes. In each discharge tube, a part crossing with a display electrode provides the smallest unit of luminescence. By causing these smallest units of luminescence to make discharge emission selectively and momentarily, two-dimensional display is accomplished.

A single discharge tube array of the above-described type can constitute a display panel. By connecting a plurality of discharge tube arrays two-dimensionally, it is possible to constitute a considerably large display panel. When discharge tube arrays are connected with each other to make a large display panel, each of these discharge tube arrays is provided with an individually allotted drive circuit for applying voltage to the display-electrodes and address-electrodes. By controlling these drive circuits, The light emitting timing for these discharge tube arrays is adjusted by controlling these drive circuits.

Patent Document 1: JP-A-2003-86142.

In the conventional display panel consisting of a plurality of discharge tube arrays, however, each array may receive the same drive voltage, but the number of the smallest units of luminescence supposed to emit light (the number of discharging units) differs from one discharge tube array to another. A discharge tube array having a greater number of discharging units undergoes a greater amount of voltage drop, resulting in decreased luminance. This poses a problem that a uniform luminance is not obtainable over the entire panel.

### DISCLOSURE OF THE INVENTION

The present invention has been proposed under the circumstance described above. It is an object of the present invention to provide a discharge tube array which can be connected with one another and can still achieve uniform overall luminance.

In order to solve the above problem, the present invention makes use of the following technical means.

A discharge tube array provided by the present invention includes a plurality of elongated discharge tubes each having an inner fluorescent layer. The discharge tube array further includes a pair of substrates sandwiching the discharge tubes in parallel to each other; a plurality of display electrodes formed in one of the substrates across the discharge tubes; and a plurality of connection terminals formed on a tube wall of the outermost one of the discharge tubes, to be connected with the display electrodes. With the above arrangement, the connection terminals enable electrical connection with the display electrodes of an additional discharge tube array used nearby.

Preferably, the display electrodes may be provided in pairs.

Preferably, the connection terminals may be provided in pairs correspondingly to the paired display electrodes. The two connection terminals in each pair may be spaced from each other by a greater distance than the distance between the two display electrodes in each pair.

Preferably, the connection terminals may have a narrower width than the display electrodes.

Preferably, the other one of the substrates is provided with a plurality of address electrodes, each of which extends along one of the discharge tubes and across the display electrodes.

Preferably, each discharge tube may be provided with an address electrode extending longitudinally of the tube.

Preferably, the connection terminals may be connected directly with the connection terminals of the additional discharge tube array.

Preferably, the connection terminals may be connected with the connection terminals of the additional discharge tube array via a connecting member.

### BRIEF DESCRIPTION OF THE DRAWINGS

FIG. 1 is an overall perspective view of a discharge tube array according to a first embodiment of the present invention.

FIG. 2 is a perspective view of a primary portion of the discharge tube array in FIG. 1.

FIG. 3 is a perspective view of a primary portion of the discharge tube array in FIG. 1.

FIG. 4 is a sectional view of a primary portion of a discharge tube array according to a second embodiment of the present invention.

FIG. 5 is a sectional view of a primary portion of a discharge tube array according to a third embodiment of the present invention.

FIG. 6 is a sectional view of a primary portion of a discharge tube array according to a fourth embodiment of the present invention.

FIG. 7 is a perspective view of a primary portion of a discharge tube array according to a fifth embodiment of the present invention.

### BEST MODE FOR CARRYING OUT THE INVENTION

Preferred embodiments of the present invention will be described below with reference to the drawings.

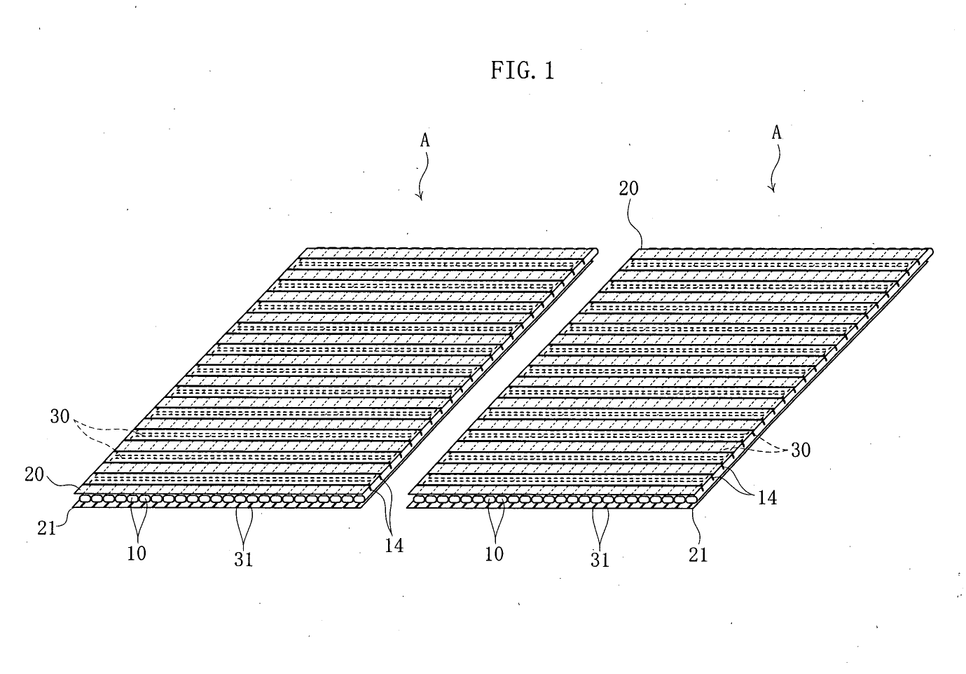

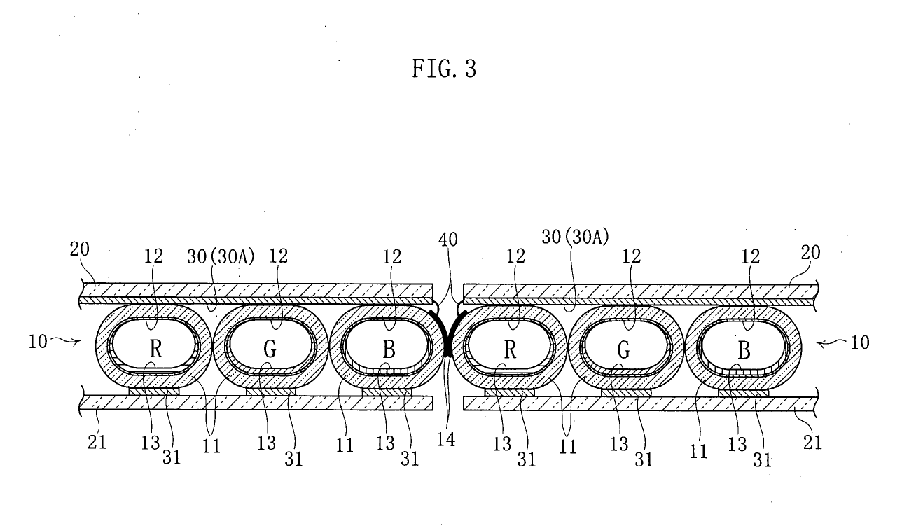

FIGS. 1 through 3 show a first embodiment of the discharge tube array according to the present invention. FIG. 1 shows a state before two discharge tube arrays A are connected, while FIG. 3 shows a state where the two discharge tube arrays A have been connected.

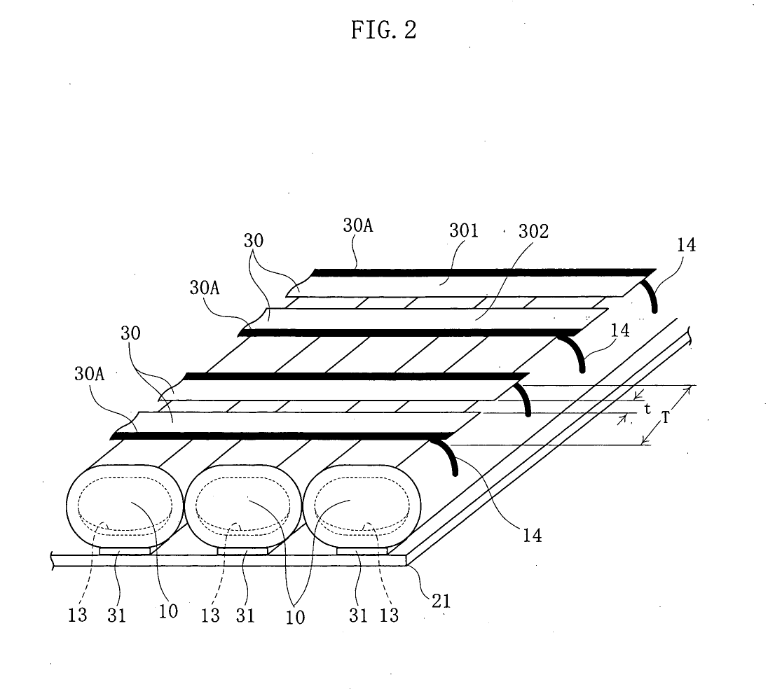

As shown in FIGS. 1 through 3, the discharge tube array A has a laminate structure including a plurality of discharge tubes 10 disposed in parallel to each other between a front, transparent substrate 20 (not illustrated in FIG. 2 for clarity) and a back substrate 21. These substrates 20, 21 are bonded to the discharge tubes 10 with adhesive for example. These two discharge tube arrays A are connected with each other two-dimensionally, to provide a larger display panel than a single-piece display panel.

The discharge tube 10 comprises a long, narrow glass tube 11 having a generally oval section, as shown in FIG. 3. The glass tube 11 has a longer diameter of about 1 mm and a shorter diameter of about 0.75 mm. The glass tube 11 has a length of about 1500 mm. The glass tube 11 has an inner wall surface provided with a MgO film 12 formed uniformly to protect the glass. The MgO film 12 has a surface provided with a fluorescent layer 13. The fluorescent layer 13 is provided by a fluorescent material for one of three principal colors R (red), G (green) and B (blue) for color display. Inside the glass tube 11, discharge gas (a mixed gas of Ne and Xe for example) is filled, with two ends of the glass tube 11 sealed.

The discharge tubes 10 are laid in the order of R, G and B. Especially, two outermost discharge tubes 10 have their side walls provided with a plurality of connection terminals 14. As shown in FIG. 1 and FIG. 2, the connection terminals 14 are spaced at a predetermined interval longitudinally of the discharge tube 10. These connection terminals 14 can be formed through printing, using silver paste for example. The discharge tube 10 as described emits visible light of RGB: Specifically, when a voltage is applied from outside, the discharge gas around the place of voltage application makes a local electric discharge thereby emitting vacuum ultraviolet rays, and the ultraviolet rays excite the fluorescent layer 13.

As shown in FIG. 3, the front and the back substrates 20, 21 are formed from a transparent resin into a plate shape, and has a height and width of about 1.5 m×2 m. The back substrate 21 may not be transparent. The front substrate 20 has an inner surface provided with a large number of display electrodes 30 across and in contact with each discharge tube. The display electrodes 30 includes scanning electrodes 301 for selecting luminescent cells and holding electrodes 302 for continuing luminescence, and these two kinds of electrodes are paired with each other. In each pair, the display electrode 30 has a part provided with a bus line 30A (on its outer side in FIG. 2) for efficient flow of electricity. The display electrode 30 including this bus line 30A has tip portions extending to respective ends of the substrate 20. At both ends of the substrate 20, the tip portion of the bus line 30A is connected with a connection terminal 14 which is formed on the outermost discharge tube 10 via a bonding wire 40 for example. In other words, the connection terminals 14 are formed in pairs for each pair of the display electrodes 30, at locations connectable with corresponding bus lines 30A. Due to this arrangement, a distance T in each pair of the connection terminals 14 is greater than an electrode-to-electrode gap (discharge gap) t in each pair of display electrodes 30. Each connection terminal 14 has a smaller width than an overall width of the display electrode 30, being approximately the same as the width of the bus line 30A. The back substrate 21 has an inner surface provided with a large number of address electrodes 31 each extending vertically along one of the discharge tubes 10 across the display electrodes 30. It should be noted here that the connection between the connection terminal and the bus line may be achieved by solder. The address electrodes may be formed on the discharge tube walls.

The discharge tubes 10 which are sandwiched between the substrates 20, 21 as described are provided with a fluorescent layer 13 on a back side of their inner walls. Each place on the discharge tube 10 crossed by a pair of the display electrodes 30 represents the smallest unit of luminescence, and a set of three smallest units of luminescence representing the three colors of RGB constitute one pixel. When displaying an image, first, a voltage is applied to the scanning electrode 301 and the address electrode 31 of those smallest units of luminescence which are supposed to emit light, to accumulate electric charge. Thereafter, a voltage is applied to the scanning electrode 301 and the holding electrode 302. As a result, only those smallest units of luminescence which are charged appropriately discharge electricity to emit light. It should be noted here that by controlling the number of times the voltage is applied to the scanning electrode 301 and the holding electrode 302, it is possible to make tone control on the RGB colors. The discharge luminescence such as this is repeated at an extremely small time interval by means of line sequential scanning for example, whereby an image is displayed two-dimensionally.

In the above embodiment, two of the above-described discharge tube arrays A are connected side by side to make a large display panel.

Typically, these discharge tube arrays A are connected with each other at the site of installation. When this operation is performed, the connection terminals 14 on one of the discharge tube arrays A is physically brought into contact with the connection terminals 14 on the other discharge tube array A as shown in FIG. 3, and while maintaining this state, the two discharge tube arrays A are fixed. In this operation, the display electrodes 30 of one discharge tube array A are brought into continuity with the display electrodes 30 of the other display electrodes 30. For this reason, only one drive circuit is provided to apply drive voltage to the display electrodes 30, via connection terminal 14 on an outer side of the discharge tube arrays A. Likewise, only one drive circuit is provided to apply drive voltage to the address electrodes 31 in the two discharge tube arrays A. It should be noted here that when the two discharge tube arrays A are connected with each other, a gap between the two is only about 200 μm, i.e. substantially smaller than the size of one pixel (about 3 mm). Therefore, such a gap does not cause any problem to displaying of images. Preferably, the connection terminals 14 are connected with each other with an anisotropic conductive film or solder.

When an image is displayed, a drive voltage is applied per two display electrodes 30 which are paired up with each other, as described earlier. Since the gap T, which is the distance between the connection terminals 14, is greater than the gap t which is the distance between the paired display electrodes 30, discharge occurs only between the display electrodes 30, with no discharge occurring between the connection terminals 14. In other words, the connection terminals 14 do not intensify the discharge luminescence. Further, the display electrodes 30 in the two discharge tube arrays A receive the same drive voltage at the same timing. Thus, even if the number of discharging units is different between the two discharge tube arrays A, a uniform luminance is obtained due to similar voltage drops, resulting in a good image display superior in color tone and image quality.

Therefore, according to the discharge tube array A offered by the present embodiment, panel size can be easily increased by connecting a plurality of the arrays, and it is possible to achieve a uniform luminance over all of the pixels throughout such a large panel.

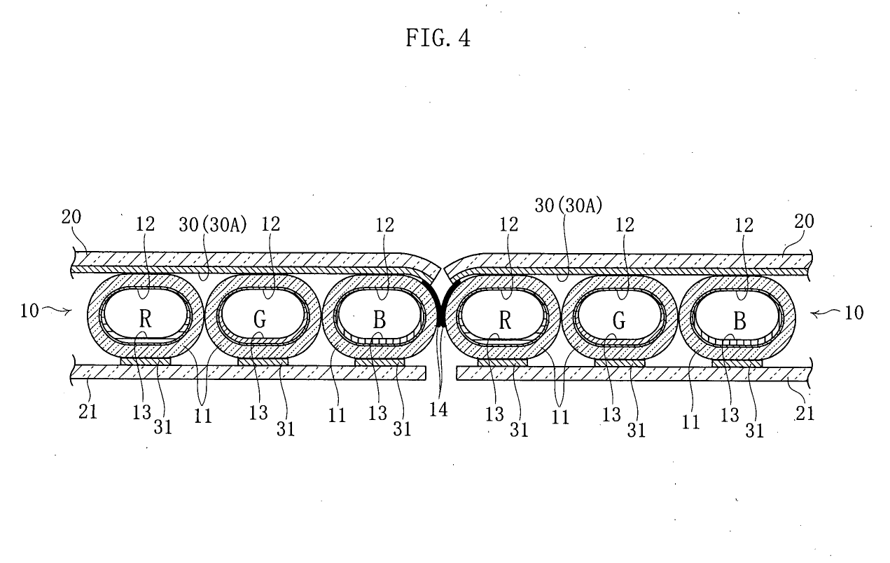

FIG. 4 through 6 show other embodiments of the discharge tube array according to the present invention. It should be noted here that in each of these embodiments, identical or similar constituent elements will be indicated by the same reference symbols, and no specific description will be made.

FIG. 4 is a sectional view of a primary portion of a discharge tube array according to a second embodiment. In the second embodiment, the outermost discharge tube 10 has its connection terminals 14 connected directly with corresponding tips of the bus line 30A via e.g. an anisotropic conductive film or solder, and for this purpose, an end of the front substrate 20 is slightly bent inwardly. Such an arrangement makes it possible to place the substrate 20 of one discharge tube array A more closely to the substrate 20 of the other discharge tube array A, allowing further reduction of the gap at the joint between the two discharge tube arrays A.

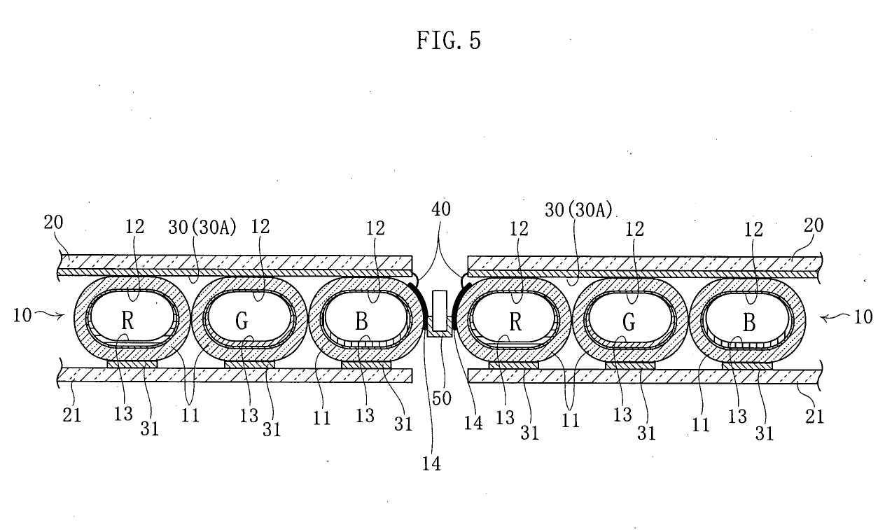

FIG. 5 is a sectional view of a primary portion of a discharge tube array according to a third embodiment. In the third embodiment, the connection terminals 14 of one discharge tube array A and the connection terminals 14 of the other discharge tube array A are connected with each other via connecting members 50. Such an arrangement facilitates connecting the connection terminals 14 with each other, and hence connecting the discharge tube arrays A.

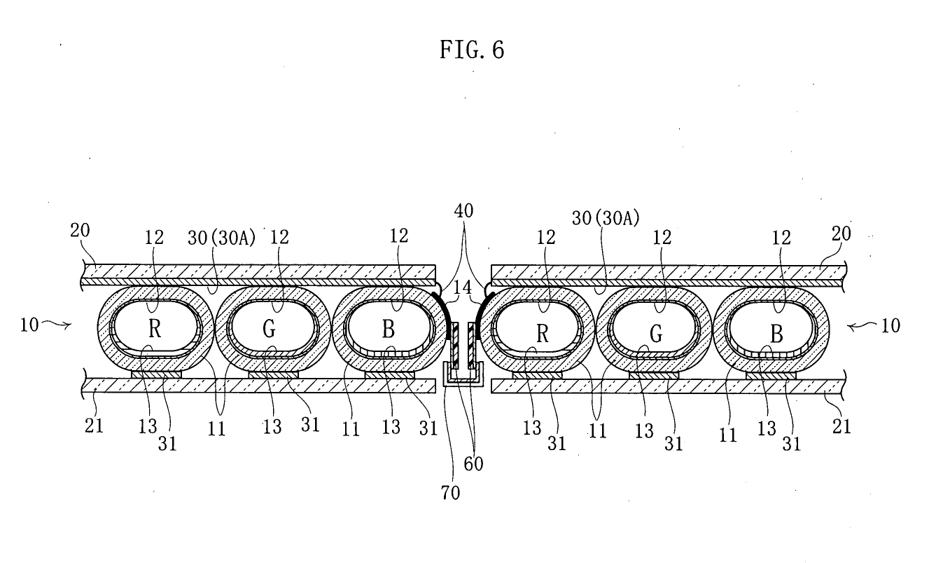

FIG. 6 is a sectional view of a primary portion of a discharge tube array according to a fourth embodiment. In the fourth embodiment, both of the discharge tube arrays A have their connection terminals 14 connected with a flexible wiring substrate 60. The two flexible wiring substrates 60 are connected with each other via a connecting member 70. Such an arrangement also facilitates connecting the connection terminals 14 with each other, and hence connecting the discharge tube arrays A.

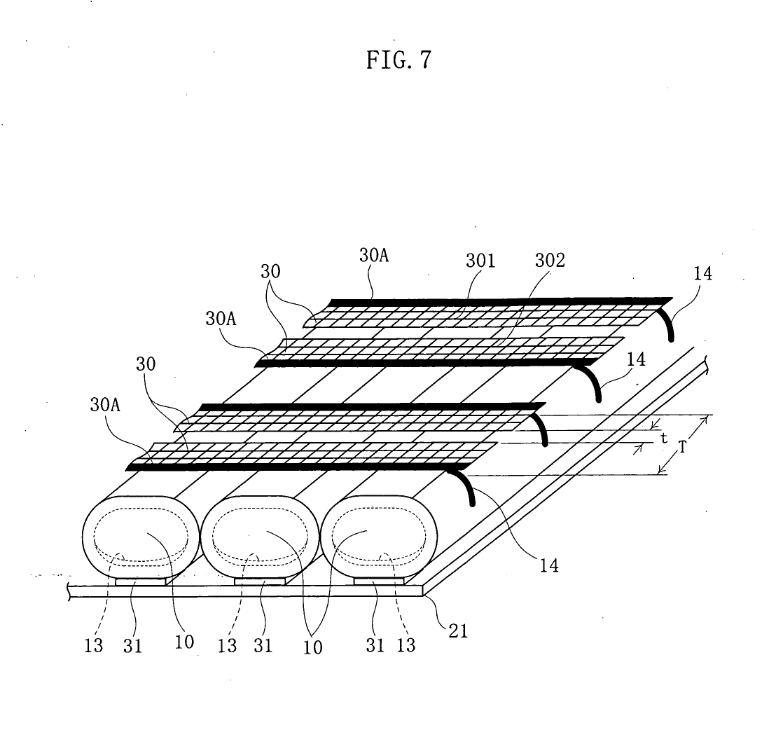

As exemplified by the fifth embodiment shown in FIG. 7, the display electrode 30 may be a grid-shaped metal electrode. The display electrode 30 may be shaped discretionary as long as it does not unduly shade the display surface, such as a ladder shape and a stick shape. Clearly the present invention is not limited by the shape of the electrodes, and the electrode may be wavy.

1. A discharge tube array provided with a plurality of elongated discharge tubes each including an internal fluorescent layer, the array comprising:
a pair of substrates sandwiching the discharge tubes in parallel to each other;
a plurality of display electrodes extending on one of the substrates across the discharge tubes; and
a plurality of connection terminals formed on a tube wall of an outermost one of the discharge tubes, the terminals being connected with the display electrodes;
wherein the connection terminals enable electrical connection with display electrodes of an adjacent discharge tube array.

2. The discharge tube array according to claim 1, wherein the display electrodes are provided in pairs.

3. The discharge tube array according to claim 2, wherein the connection terminals are provided in pairs correspondingly to the paired display electrodes, the two connection terminals in each pair being spaced from each other by a greater distance than a distance between the two display electrodes in each pair.

4. The discharge tube array according to claim 3, wherein the connection terminals have a narrower width than the display electrodes.

5. The discharge tube array according to claim 1, wherein the other one of the substrates in the pair is provided with a plurality of address electrodes each extending along one of the discharge tubes and across the display electrodes.

6. The discharge tube array according to claim 1, wherein each discharge tube is provided with an address electrode extending longitudinally of said each discharge tube.

7. The discharge tube array according to claim 1, wherein the connection terminals are connected directly with the connection terminals of the adjacent discharge tube array.

8. The discharge tube array according to claim 1, wherein the connection terminals are connected with the connection terminals of the adjacent discharge tube array via a connecting member.
